(19) United States
(12) Patent Application Publication
(10) Pub. No.: US 2011/0316943 A1
(43) Pub. Date: Dec. 29, 2011

(54) LIQUID EJECTING HEAD AND LIQUID EJECTING APPARATUS

(75) Inventors: Hiroshige OWAKI, Okaya-shi (JP); Shigeki SUZUKI, Shiojiri-shi (JP); Hiroyuki KOBAYASHI, Shiojiri-shi (JP)

(73) Assignee: Seiko Epson Corporation, Shinjuku-ku (JP)

(21) Appl. No.: 13/081,016

(22) Filed: Apr. 6, 2011

(30) Foreign Application Priority Data
Jun. 29, 2010 (JP) 2010-148241

(51) Int. Cl. B41J 2/175

(52) U.S. Cl. 347/85

(57) ABSTRACT

The flow path unit includes a flow path unit main body to which the liquid supply needle is attached on the upstream side and including a flow path portion with the liquid flow path formed therein, the flow path portion projecting from a lower face of the flow path unit main body, and a cover member fixed to the flow path unit main body and including a wall portion formed so as to surround the flow path portion, the wall portion having a height that reaches the case member.

The entire disclosure of Japanese Patent Application No: 2010-148241, filed Jun. 29, 2010 are expressly incorporated by reference herein.

### BACKGROUND

1. Technical Field

The present invention relates to a liquid ejecting head that ejects through a nozzle a liquid supplied from a liquid reservoir to a head main body via a liquid supply path, and to a liquid ejecting apparatus that includes such a liquid ejecting head.

2. Related Art

In an ink jet recording head, a typical example of a liquid ejecting head, ink is generally supplied from an ink cartridge (liquid reservoir) loaded with the ink to a pressure chamber in a head main body, through an ink flow path (liquid flow path). Then upon applying a pressure to the pressure chamber with a pressure generator such as a piezoelectric element, an ink droplet is ejected through a nozzle communicating with the pressure chamber.

Specifically, the ink jet recording head includes, for example as disclosed in JP-A-2003-11383, a head main body, a head case in which a plurality of head main bodies are fixed, and a cartridge case to which the head case is fixed, and a circuit board that provides a signal for driving the piezoelectric element is provided between the head case and the cartridge case.

In the case where the circuit board is provided between the head case and the cartridge case as above, it is preferable that the entire periphery of the circuit board is surrounded by (a sidewall of) the cartridge case. This is because such a configuration suppresses ink mist from sticking to the circuit board, thereby preventing malfunction of the circuit board due to ink mist stuck thereto.

The ink jet recording head thus configured may, however, fail to fully protect the circuit board from the ink mist. To be more specific, a plurality of flow path portions each including an ink passage are formed so as to project from a lower face of the cartridge case (flow path unit). Some of those flow path portions are tilted with respect to the surface of the flow path unit. To secure sufficient rigidity of the tilted flow path portions, it is preferable to form a supporting portion 890 as an extension of the flow path portion 840, between the flow path portion 840 and the lower surface 830 of the flow path unit 800, for example as shown in FIG. 7A.

The flow path unit 800 is typically formed by resin injection molding, and hence such a shape as the supporting portion 890 is prone to be unevenly cured during a cooling process, resulting in formation of a recess, what is known as a sink mark, on an inner surface of an ink supply hole 850 formed in the flow path portion 840.

Accordingly, it is preferable to form an undercut portion 891 as shown in FIG. 7B, between the tilted flow path portion 840 and the supporting portion 890 (between the flow path portion 840 and the lower surface 830 of the flow path unit 800). Such arrangement suppresses formation of the recess originating from the sink mark.

To form such an undercut portion, however, it is necessary to slide a die corresponding to the undercut portion (for example, a slide core) and draw out the die. Accordingly, in the case where a sidewall is present around the flow path unit 800, an opening has to be provided in the sidewall, for the die to be slid therethrough. Consequently, the ink mist that has intruded into the flow path unit through the opening may stick to the circuit board. Although the intrusion of the ink mist could be prevented by, for example, covering the opening with an additional part, such a process would complicate the manufacturing process and lead to an increase in manufacturing cost.

Further, in the case where the opening is to be formed in the flow path unit, it is preferable to make the opening as small as possible. Such a requirement leads to another drawback that the degree of freedom in designing the flow path portion is restricted to a certain extent.

The foregoing problems arise not only in the ink jet recording head, but broadly in liquid ejecting heads that eject a liquid other than ink.

### SUMMARY

An advantage of some aspects of the invention is that a liquid ejecting head and a liquid ejecting apparatus are provided that can suppress the liquid from sticking to the circuit board and still significantly increase the degree of freedom in design.

In one aspect, the invention provides a liquid ejecting head including: a head main body that ejects a liquid droplet; a case member to which the head main body is fixed; a flow path unit including a liquid flow path connecting a liquid supply needle and the case member, the liquid supply needle being attached to an upstream side of the flow path unit and the case member being attached to a downstream side thereof; and a circuit board provided between the case member and the flow path unit, and to which a pressure generating element constituting a part of the head main body is connected; wherein the flow path unit includes: a flow path unit main body to which the liquid supply needle is attached on the upstream side and including a flow path portion with the liquid flow path formed therein, the flow path portion projecting from a lower face of the flow path unit main body; and a cover member fixed to the flow path unit main body and including a wall portion formed so as to surround the flow path portion, the wall portion having a height that reaches the case member.

In the liquid ejecting head thus configured, since the periphery of the circuit board is surrounded by the cover member, the liquid can be effectively prevented from intruding into the flow path unit. As a result, the liquid can be effectively kept from sticking to the circuit board. Also, the flow path unit main body itself, constituting an essential part of the flow path unit, does not include a wall therearound, and hence the sliding direction of the die for forming the undercut portion is free from restriction. Consequently, the degree of freedom in designing the flow path unit can be significantly increased.

Preferably, the wall portion of the cover member may be formed so as to substantially abut an abutment portion of the case member, and may include a first stepped portion making a difference in height in a thicknesswise direction of the wall portion, formed on a distal facet thereof, and the case member may include a second stepped portion formed on a distal facet of the abutment portion so as to be engaged with the first stepped portion.

Such a configuration securely suppresses the liquid from intruding into the flow path unit without the need to bond the wall portion and the abutment portion with an adhesive or the like.

Preferably, the cover member may include a bottom face opposing the upstream side of the flow path unit main body and including an opening through which the liquid supply needle is exposed, and may be fixed to the flow path unit main body so as to cover the flow path unit main body on the side of the liquid supply needle.

Preferably, the flow path unit main body may include a ridge portion formed on an outer surface on the side of the liquid supply needle so as to protrude toward the bottom face of the cover member, and the bottom face of the cover member may include a recess to be engaged with the ridge portion.

The cover member thus configured effectively suppresses the liquid from intruding into the flow path unit, hence from sticking to the circuit board.

In another aspect, the invention provides a liquid ejecting apparatus including the foregoing liquid ejecting head. Thus, the invention provides a liquid ejecting apparatus having higher reliability and durability.

### BRIEF DESCRIPTION OF THE DRAWINGS

The invention will be described with reference to the accompanying drawings, wherein like numbers reference like elements.

FIG. 1 is an exploded perspective view of a recording head according to a first embodiment of the invention.

FIG. 2 is a cross-sectional view of the recording head according to the first embodiment of the invention.

FIG. 3 is an exploded perspective view of a head main body according to the first embodiment of the invention.

FIG. 4 is a cross-sectional view of the head main body according to the first embodiment of the invention.

FIG. 5 is a fragmentary cross-sectional view of the recording head according to the first embodiment of the invention.

FIG. 6 is a perspective view showing an outline of a recording apparatus according to an embodiment of the invention.

FIGS. 7A and 7B are cross-sectional views of a conventional flow path unit.

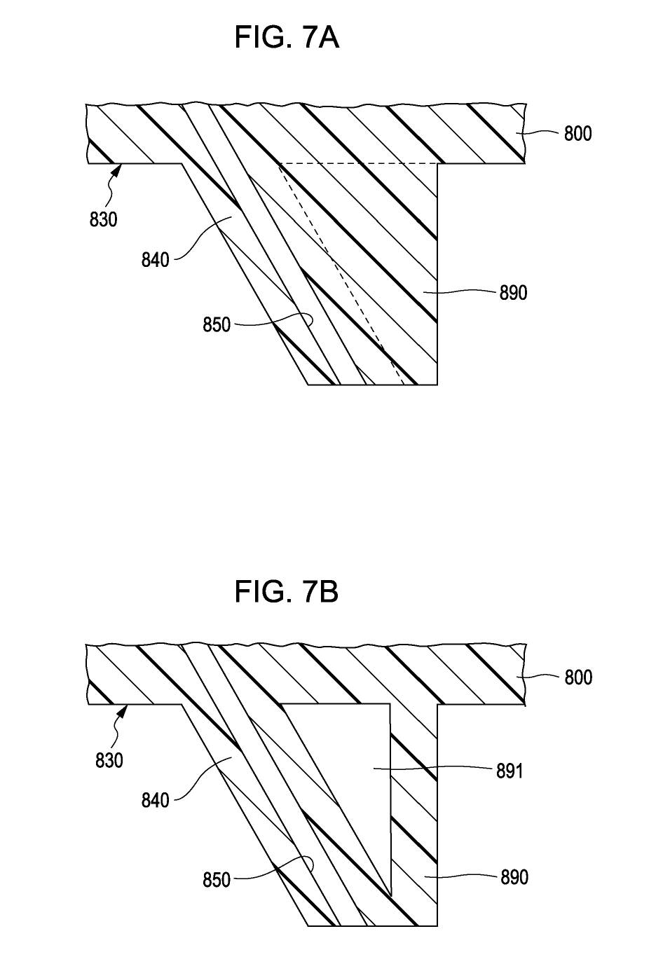

### DESCRIPTION OF EXEMPLARY EMBODIMENTS

Hereafter, embodiments of the invention will be described in detail.

### First Embodiment

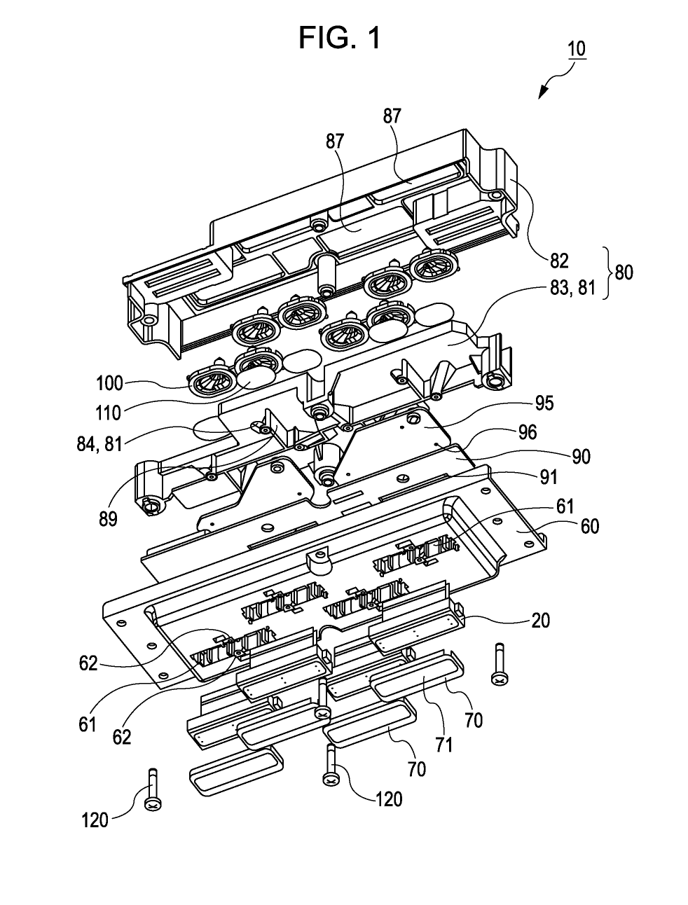

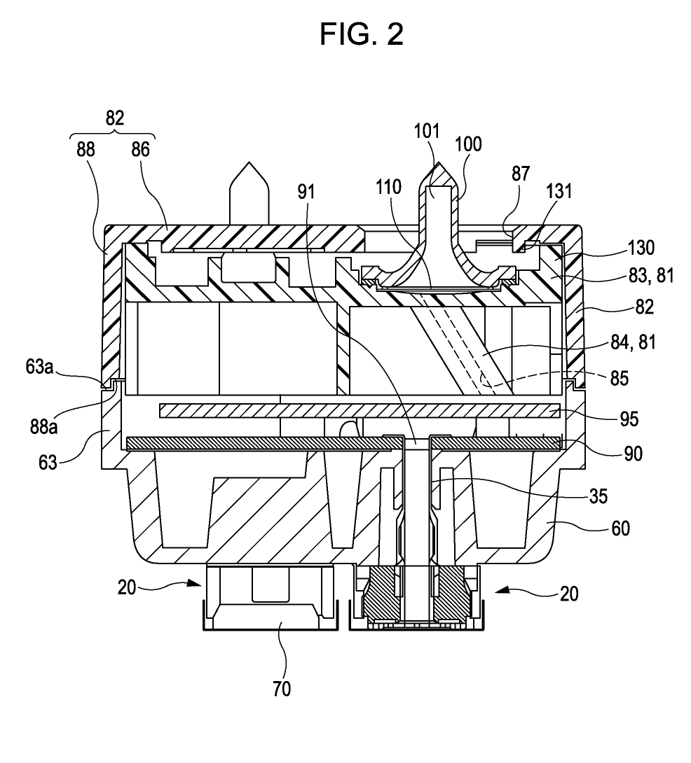

FIG. 1 is an exploded perspective view of an ink jet recording head according to a first embodiment, exemplifying the liquid ejecting head of the invention, and FIG. 2 is a cross-sectional view thereof in an assembled state.

As shown in FIGS. 1 and 2, the ink jet recording head (hereinafter, simply recording head) 10 includes a plurality of head main bodies 20 that each eject an ink droplet, a case member 60 to which the head main bodies 20 are fixed, a flow path unit 80 attached to the case member 60 on the side opposite the head main bodies 20, and a circuit board 90 provided between the case member 60 and the flow path unit 80.

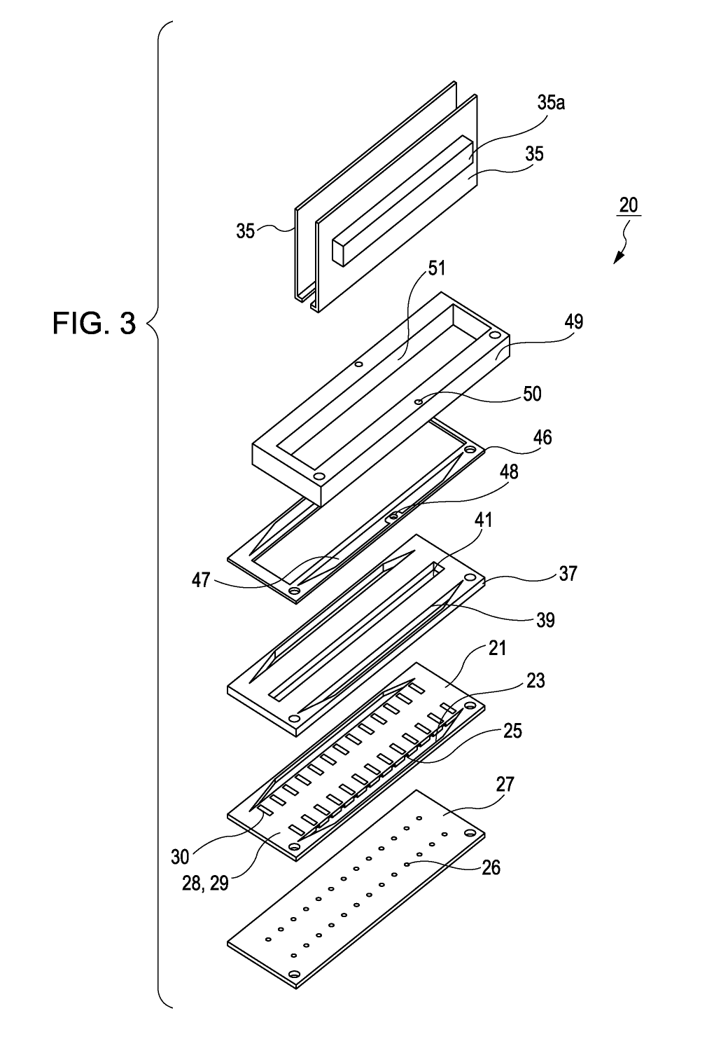

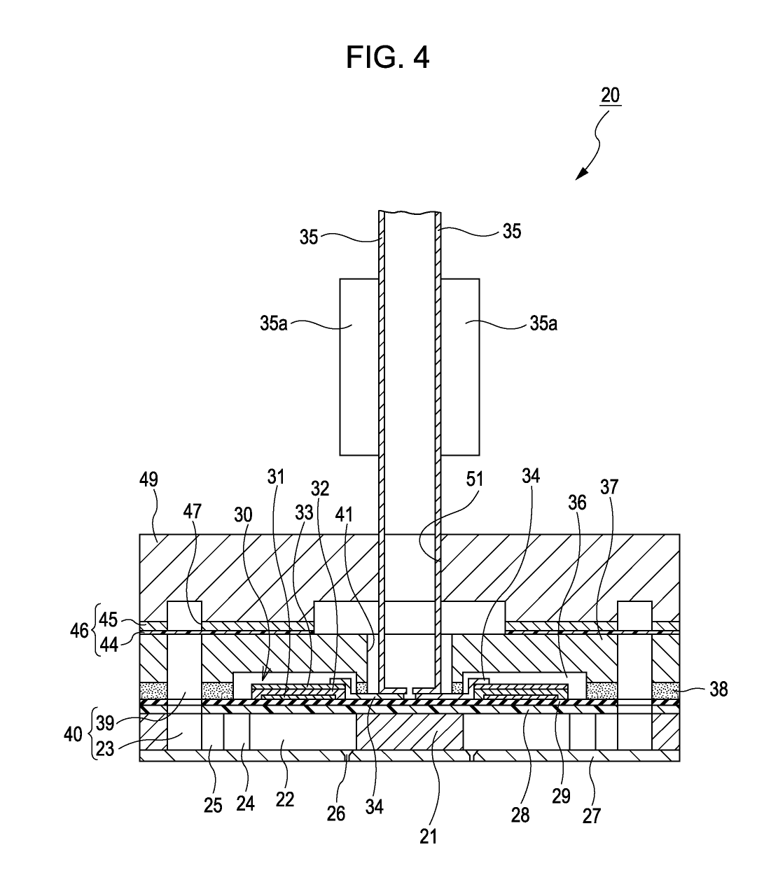

To start with, the structure of the head main body 20 will be described referring to FIGS. 3 and 4. FIG. 3 is an exploded perspective view of the head main body according to the first embodiment, and FIG. 4 is a cross-sectional view of a pressure chamber in the head main body, taken in a longitudinal direction of the pressure chamber.

As shown therein, a plurality of pressure chambers 22 are aligned in a widthwise direction thereof in two rows, on a flow path substrate 21 included in the head main body 20. Communication channels 23 are provided along outer regions of the respective rows of the pressure chambers 22, and the communication channels 23 and each of the pressure chambers 22 are connected through an ink supply path 24 and a communication path 25 provided for each pressure chamber 22.

To one of the faces of the flow path substrate 21, a nozzle plate 27 is attached that is perforated with nozzles 26 each communicating with an end portion of the pressure chamber 22 opposite the ink supply path 24.

Piezoelectric elements 30 are provided on the opposite face of the flow path substrate 21 with an elastic film 28 and an insulation film 29 therebetween. The piezoelectric elements 30 each include a first electrode 31, a piezoelectric layer 32, and a second electrode 33. The second electrode 33 of the piezoelectric element 30 is connected to a lead electrode 34 extending to an upper surface of the insulation film 29. The lead electrode 34 has one end connected to the second electrode 33 and the other end connected to a driver wiring 35, which is a flexible COF substrate on which a driver IC 35a is mounted that drives the piezoelectric element 30. Thus, the driver wiring 35 has one end connected to the lead electrode 34 and the other end fixed to the circuit board 90 (see FIG. 2).

On the flow path substrate 21 with such piezoelectric elements 30 mounted thereon, a cover substrate 37 including piezoelectric element enclosing portions 36, spaces provided for protecting the piezoelectric elements 30, are mounted via an adhesive 38 in a region corresponding to the piezoelectric elements 30. Also, the cover substrate 37 includes manifold stem portions 39. In this embodiment, the manifold stem portions 39 each communicate with the respective communication channels 23 in the flow path substrate 21, thereby constituting parts of manifolds 40 each serving as a common ink chamber for the pressure chambers 22.

The cover substrate 37 also includes a through hole 41 formed so as to penetrate therethrough in a thicknesswise direction. In this embodiment, the through hole 41 is located between the two piezoelectric element enclosing portions 36. A portion of the lead electrode 34 close to its end portion opposite the piezoelectric element 30 is exposed inside the through hole 41.

To the cover substrate 37, further, a compliance substrate 46 including a sealing film 44 and a fixing plate 45 is attached. The sealing film 44 is made of a flexible material having low rigidity, and serves to seal one of the sides of the manifold stem portions 39. The fixing plate 45 is made of a hard material such as a metal. The fixing plate 45 includes openings 47 formed through the entire thickness thereof, in regions opposing the manifolds 40. Accordingly, the manifolds 40 are sealed only with the flexible sealing film 44, on the side opposite the manifold stem portions 39. The compliance substrate 46 also includes ink inlet ports 48 through which the ink is introduced into the manifolds 40.

A head case 49 is fixed onto the compliance substrate 46. The head case 49 includes ink inlet paths 50 each communicating with the respective ink inlet ports 48 to supply the ink from a reservoir such as a cartridge to the manifolds 40. The head case 49 also includes a wiring duct 51 communicating with the through hole 41 of the cover substrate 37, and the driver wiring 35 is inserted through the wiring duct 51 to be connected to the lead electrode 34.

Each of the head main bodies 20 thus configured is fixed to the case member 60. Referring again to FIGS. 1 and 2, a plurality (in this embodiment, four) of head main bodies 20 is attached to a bottom face of the case member 60.

The case member 60 includes through holes 61 penetrating therethrough in a thicknesswise direction, at positions corresponding to the individual head main bodies 20. The case member 60 also includes supply paths 62 located on outer sides of the through holes 61 and communicating with the ink inlet paths 50 provided in the head case 49 of the head main body 20. Thus, the head case 49 of each head main body 20 is attached along the peripheral edge of the corresponding through hole 61, with the driver wiring 35 of the head main body 20 inserted into the through hole 61, and the ink inlet paths 50 and the supply paths 62 set to communicate with each other.

Also, a cover head 70 having a window 71 through which the nozzles 26 are exposed is attached to the bottom face of the head main body 20 fixed to the case member 60.

The flow path unit 80 is fixed to the case member 60 on the side opposite the head main bodies 20, with the circuit board 90 and a sealing member 95 formed of rubber or the like therebetween.

On the circuit board 90, electronic components and wirings for driving the piezoelectric elements 30 are mounted. The circuit board 90 includes connection holes 91 penetrating therethrough in a thicknesswise direction. The driver wirings 35 of the head main bodies 20 are inserted through the connection holes 91, and electrically connected with the wirings on the circuit board 90.

The flow path unit 80 includes a flow path unit main body 81 and a cover member 82. The circuit board 90 and the sealing member 95 are located between the flow path unit main body 81 of the flow path unit 80 and the case member 60.

The flow path unit main body 81 includes a base portion 83 on which a plurality of ink supply needles 100 inserted to the ink cartridge are fixed, and a flow path portion 84 projecting from the lower face of the base portion 83. The flow path portion 84 includes ink supply holes 85 each having an opening facing the corresponding ink supply needle 100, on an end portion. The other end portion of the ink supply hole 85 is connected to the supply path 62 of the case member 60, via a supply passage 96 provided in the sealing member 95.

Also, a filter 110 is provided at the opening formed at one end portion of the ink supply hole 85, for removing bubbles and foreign substances from the ink. The ink supply needle 100 is attached to the base portion 83 of the flow path unit main body 81 via the filter 110.

The ink supply needles 100 each include a through path 101 communicating with the ink supply hole 85. Once the ink supply needle 100 is inserted into the ink cartridge (not shown), the ink inside the ink cartridge is supplied to the manifold 40 in the head main body 20, through the through path 101 of the ink supply needle 100, the ink supply hole 85, and the supply path 62.

The cover member 82 is generally of a box shape with an opening formed on a lower side, i.e., the side of the head main body 20, and constitutes a unified body with the flow path unit main body 81 upon being superposed therewith from the side of the ink supply needle 100. To be more specific, the cover member 82 includes a bottom face 86 (though oriented upward) having openings 87 through which the ink supply needles 100 are exposed, and a wall portion 88 formed so as to surround the flow path portion 84 in a height that reaches the case member 60.

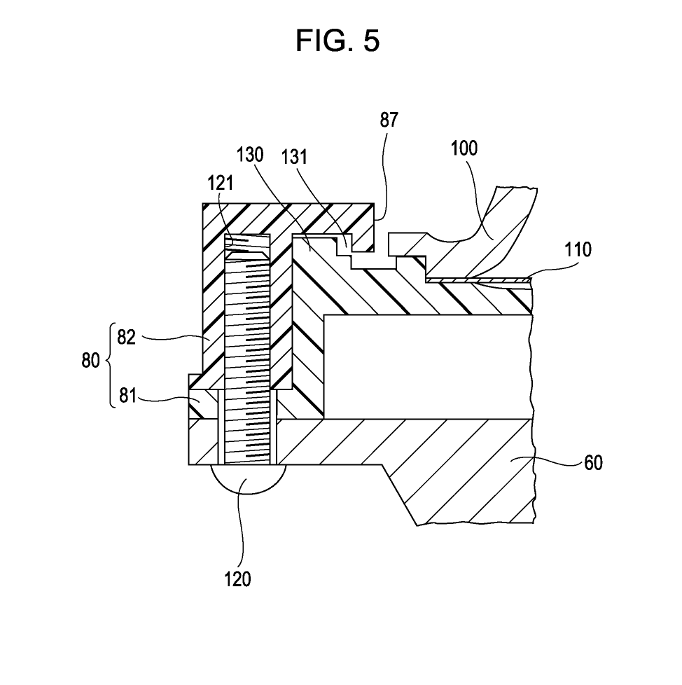

The cover member 82 thus configured and the case member 60 are coupled as shown in FIG. 5, with fastening members 120 such as a screw, with the cover member 82 superposed on the flow path unit main body 81 from the side of the ink supply needle 100, and with the circuit board 90 and the sealing member 95 interposed between the flow path unit main body 81 and the case member 60. Thus the flow path unit main body 81 and the cover member 82 are unified so that the flow path unit 80 is formed, and the flow path unit 80 and the case member 60 are unified. In this embodiment, the flow path unit 80 and the case member 60 are coupled with four fastening members 120 respectively located on each of the four sides thereof (see FIG. 1). More specifically, the cover member 82 of a generally rectangular shape includes a female threaded hole 121 formed on each of the four sides, and the flow path unit 80 and the case member 60 are unified upon inserting the fastening members 120 in the female threaded holes 121 and screw-fitting therewith, from the side of the case member 60.

In the recording head 10 thus configured, the periphery of the circuit board 90 on which the electronic components for driving the piezoelectric elements 30 are mounted is covered with the flow path unit 80 and the case member 60. In other words, the circuit board 90 is accommodated inside a space formed between the cover member 82 and the case member 60. Such a configuration effectively prevents the ink mist, emerging upon ejecting ink droplets through the nozzles 26 of the head main body 20, from sticking to the circuit board 90.

Referring again to FIG. 2, the wall portion 88 of the cover member 82 has its distal facet substantially abutted to an abutment portion 63 of the case member 60. Here, the expression “substantially abutted” refers not only to a state where the wall portion 88 and the abutment portion 63 of the case member 60 are physically in contact with each other, but also to a state where the wall portion 88 and the abutment portion 63 of the case member 60 are disposed close to each other. In other words, a small gap may be present between the wall portion 88 and the abutment portion 63 of the case member 60. In this embodiment, the abutment portion 63 of the case member 60 is formed along the outer peripheral surface of the case member 60 so as to extend toward the cover member 82. The case member 60 and the cover member 82 are coupled such that the distal facet of the wall portion 88 and the distal facet of the abutment portion 63 are abutted to each other.

Also, the distal facet of the wall portion 88 includes a first stepped portion 88a making a difference in height in a thicknesswise direction of the wall portion 88, and the distal facet of the abutment portion 63 of the case member 60 includes a second stepped portion 63a formed in such a shape that fits the first stepped portion 88a. In this embodiment, the first stepped portion 88a is formed such that a portion of the distal facet inner than the center in the thicknesswise direction of the wall portion 88 is recessed toward the bottom face 86, with respect to the outer portion of the distal facet. The second stepped portion 63a is formed so as to fit the first stepped portion 88a, such that an inner portion of the distal facet of the abutment portion 63 protrudes toward the cover member.

Forming thus the stepped portion on the distal facets of the wall portion 88 and the abutment portion 63 and causing the distal facets to substantially abut each other can effectively suppress ink mist from intruding into the flow path unit 80. The intrusion of the ink mist could also be prevented, for example, by sealing between the distal facets of the wall portion 88 and the abutment portion 63 with an adhesive or the like. Such a method incurs, however, a drawback such as complication of the manufacturing process and an increase in cost. In contrast, forming the stepped portion on the distal facets of the wall portion 88 and the abutment portion 63 and causing the distal facets to substantially abut each other as above can eliminate the need to employ an adhesive to seal between the wall portion 88 and the abutment portion 63, and still effectively suppress the intrusion of the ink mist from intruding into the flow path unit 80. Consequently, the ink mist can be substantially prevented from sticking to the circuit board 90.

In this embodiment, further, the flow path unit main body 81 includes a ridge portion 130 continuously formed along the entire periphery thereof on the side of the ink supply needles 100, so as to protrude toward the bottom face 86 of the cover member 82. The bottom face 86 of the cover member 82 includes a recess 131 to be engaged with the ridge portion 130. Thus, the flow path unit main body 81 and the cover member 82 are coupled with each other such that the ridge portion 130 is engaged with the recess 131. Such a configuration effectively suppress the intrusion of the ink mist through the openings 87 into the flow path unit 80, thereby further assuring the prevention of the ink mist from sticking to the circuit board 90.

Further, the ridge portion 130 and the recess 131 may be engaged, with an adhesive applied to the distal facet of the ridge portion 130, to thereby seal between the ridge portion 130 and the bottom face 86 with the adhesive. Such arrangement further assures the prevention of the ink mist from intruding into the flow path unit 80. Besides, the ink around the ink supply needles 100 can be prevented from leaking outward.

The flow path unit main body 81 and the cover member 82 constituting the flow path unit 80 are formed by a resin injection molding process. In the case of forming the flow path unit main body 81 by the injection molding, a so-called undercut portion has to be formed between the base portion 83 and the flow path portion 84 projecting therefrom. For example, the flow path portion 84 obliquely projecting from the base portion 83 is supported by a support wall 89 erected on the base portion 83 as shown in FIG. 1, in which case the undercut portion has to be formed between the flow path portion 84 and the support wall 89 (or base portion 83). The undercut portion serves to suppress formation of a sink mark during the resin molding process, thereby preventing formation of a recess in the ink supply hole 85 formed inside the flow path portion 84.

The die for forming the undercut portion has to be slid and drawn out after the molding. The flow path unit 80 according to the invention includes the flow path unit main body 81 and the cover member 82, and a wall is absent along the outer periphery of the flow path unit main body 81 including the flow path portion 84. Accordingly, the die for forming the undercut portion can be slid and drawn out in a desired direction. Such a configuration allows, therefore, the undercut portion to be easily formed in the flow path unit main body 81, and contributes to significantly increasing the degree of freedom in designing the flow path unit main body 81. Also, the recording head 10 can be made smaller in size and the manufacturing cost can be reduced. Moreover, there is no need to form an opening for drawing out the die therethrough in the cover member 82 and the wall portion 88 can be provided along the entire periphery, which leads to increased rigidity of the cover member 82. Consequently, the rigidity of the overall flow path unit 80, as a unified structure of the flow path unit main body 81 and the cover member 82, can also be improved.

Thus, in the recording head 10 according to the invention, the flow path unit 80 is constituted of the flow path unit main body 81 including the flow path portion 84, and the cover member 82 including the wall portion 88 surrounding the flow path unit main body 81. Such a structure suppresses the ink from sticking to the circuit board 90 thereby preventing electrical malfunction, and significantly increases the degree of designing freedom.

### Additional Embodiments

Although the embodiment of the invention has been described as above, it is to be understood that the invention is in no way limited to the foregoing embodiment.

For example, although the foregoing embodiment represents the case where the flow path unit includes the flow path unit main body and the cover member including the bottom face and the wall portion, the flow path unit may have a different structure. It is not mandatory that the cover member includes the bottom face. The cover member may only include the wall portion, and the flow path unit main body may be formed so as to cover the face of the flow path unit on the side of the ink supply needles.

Also, the structure of the head main body according to the foregoing embodiment is merely exemplary. Although the thin-film piezoelectric element is employed as the pressure generating element in the recording head 10, the structure of the pressure generating element is not specifically limited. To cite a few examples, a thick film piezoelectric element formed by adhering a green sheet, or a vertical vibration type piezoelectric element, constituted of alternately stacked piezoelectric materials and electrode materials so as to axially expand and contract, may be employed. Further, the pressure generating element may be constituted of a heating element disposed in the pressure chamber, so that a bubble generated by the heat of the heating element ejects a liquid droplet through the nozzle, or what is known as a static actuator that generates static electricity between a vibrating plate and an electrode, thereby deforming the vibrating plate so as to eject a liquid droplet through the nozzle.

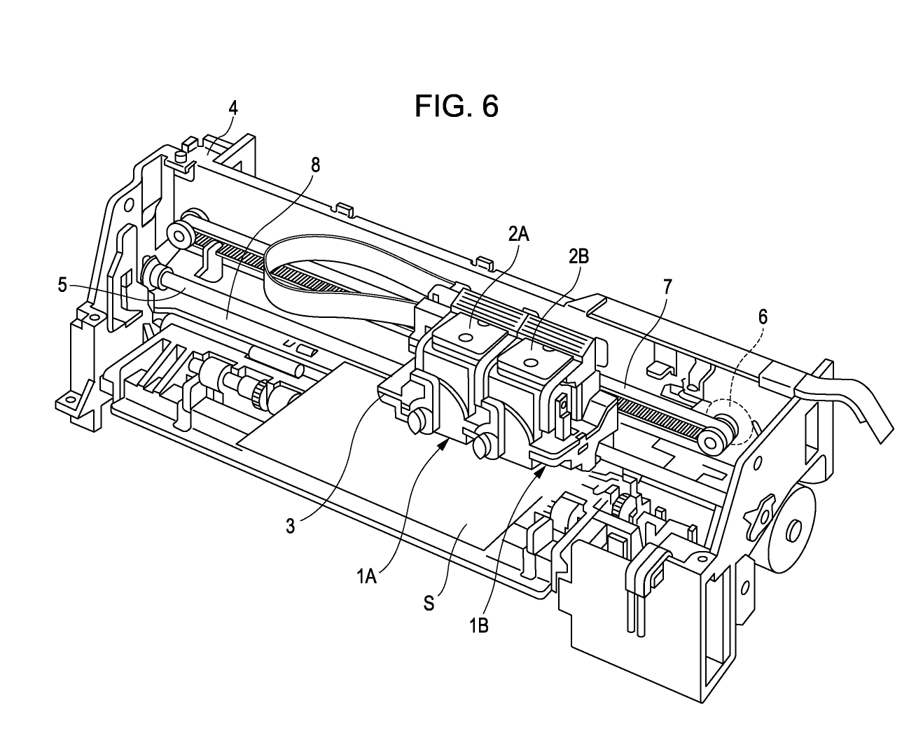

The ink jet recording head according to the foregoing embodiment can constitute a part of an ink jet recording head unit including an ink flow path communicating with an ink cartridge or the like, and be incorporated in an ink jet recording apparatus. FIG. 6 is a schematic perspective view showing such an ink jet recording apparatus.

As shown in FIG. 6, the recording head units 1A and 1B including the recording heads respectively include detachable cartridges 2A and 2B serving as the ink supplier, and a carriage 3 with the recording head units 1A and 1B mounted thereon is provided so as to axially move along a carriage shaft 5 mounted in the apparatus main body 4. The recording head units 1A and 1B are configured to dispense, for example, a black ink composition and color ink composition.

When a driving force of a driving motor 6 is transmitted to the carriage 3 through a plurality of gears (not shown) and a timing belt 7, the carriage 3 with the recording head units 1A and 1B mounted thereon is caused to move along the carriage shaft 5. The apparatus main body 4 includes a platen 8 provided along the carriage shaft 5, so that a recording sheet S, a recording medium such as paper supplied by a feed roller (not shown), is wound on the platen 8 thus to be transported thereon.

Although the liquid ejecting head is exemplified by the ink jet recording head in the foregoing embodiments, the invention is broadly applicable to various liquid ejecting heads and liquid ejecting apparatus incorporated therewith. Examples of such liquid ejecting head include a recording head for use in an image recording apparatus such as a printer, a color material ejecting head employed for manufacturing a color filter for an LCD and the like, an electrode material ejecting head employed for manufacturing an electrode in an organic EL display or a field discharge display (FED), and an bioorganic ejecting head for manufacturing a biochip.

1. A liquid ejecting head comprising:
a head main body that ejects a liquid droplet;
a case member to which the head main body is fixed;
a flow path unit including a liquid flow path connecting a liquid supply needle and the case member, the liquid supply needle being attached to an upstream side of the flow path unit and the case member being attached to a downstream side thereof; and
a circuit board provided between the case member and the flow path unit, and to which a pressure generating element constituting a part of the head main body is connected;
wherein the flow path unit includes:
a flow path unit main body to which the liquid supply needle is attached on the upstream side and including a flow path portion with the liquid flow path formed therein, the flow path portion projecting from a lower face of the flow path unit main body; and
a cover member fixed to the flow path unit main body and including a wall portion formed so as to surround the flow path portion, the wall portion having a height that reaches the case member.

2. The liquid ejecting head according to claim 1, wherein the wall portion of the cover member is formed so as to substantially abut an abutment portion of the case member, and includes a first stepped portion making a difference in height in a thicknesswise direction of the wall portion, formed on a distal facet thereof, and
the case member includes a second stepped portion formed on a distal facet of the abutment portion so as to be engaged with the first stepped portion.

3. The liquid ejecting head according to claim 1, wherein the cover member includes a bottom face opposing the upstream side of the flow path unit main body and including an opening through which the liquid supply needle is exposed, and is fixed to the flow path unit main body so as to cover the flow path unit main body on the side of the liquid supply needle.

4. The liquid ejecting head according to claim 3, wherein the flow path unit main body includes a ridge portion formed on an outer surface on the side of the liquid supply needle so as to protrude toward the bottom face of the cover member, and the bottom face of the cover member includes a recess to be engaged with the ridge portion.

5. A liquid ejecting apparatus comprising the liquid ejecting head according to claim 1.

6. A liquid ejecting apparatus comprising the liquid ejecting head according to claim 2.

7. A liquid ejecting apparatus comprising the liquid ejecting head according to claim 3.

8. A liquid ejecting apparatus comprising the liquid ejecting head according to claim 4.
